(19) United States
(12) Patent Application Publication
(10) Pub. No.: US 2005/0012384 A1
(43) Pub. Date: Jan. 20, 2005

(54) Bicycle wheel particularly for racing and mountain bicycle

(76) Inventor: Moreno Fioravanti, Ozzano dell'Emilia (FR)

Correspondence Address: REED SMITH LLP, 3110 FAIRVIEW PARK DRIVE, SUITE 1400, FALLS CHURCH, VA, 22042, US

(21) Appl. No.: 10/496,867

(22) PCT Filed: Oct. 9, 2002
(86) PCT No.: PCT/EP02/11314

(30) Foreign Application Priority Data
Nov. 2, 2001 (IT) BO2001U000092

(51) Int. Cl. B60B 1/02

(52) U.S. Cl. 301/55

(57) ABSTRACT

A bicycle wheel, particularly for racing and mountain bicycle, comprising a hub (3) that has two flanges (4,5) connected to a rim (2) by way of wire spokes, said wire spokes forming a first plurality of radial elements (6), which are mutually angularly equidistant by a preset angle and connect said rim (2) to the first flange (4) of said hub (3), and a second plurality of radial elements (6), which are mutually angularly equidistant by said angle, are offset by half of said angle with respect to said first plurality and connect said rim (2) to the second flange (5) of said hub (3), each one of said radial elements (6) being constituted by a first wire spoke (7) and a second wire spoke (8) which are substantially parallel.

### TECHNICAL FIELD

The present invention relates to a bicycle wheel particularly for racing and mountain bicycle.

### BACKGROUND ART

Racing bicycles and bicycles for excursions on rough or mountainous terrain are currently provided with extremely lightweight wheels by using new materials and modern manufacturing technologies.

At the same time, such wheels must have great mechanical strength and a rigidity that is adapted for the characteristics of the road surface. Wheels that have a particularly rigid behavior when affected by the stresses encountered in use are those formed monolithically by pressure die-casting, which however often are too heavy and can be used only in particular conditions or situations.

A compromise between rigidity and low weight can be, achieved with conventional wheels in which the rim is connected to the hub by way of a distribution of wire spokes having various shapes and dimensions. However, such wheels have drawbacks due to the fact that the wire spokes, by crossing each other, are in mutual contact in one or more points: this contact causes inward flexing of the wire spokes after assembly, with a consequent concentration of abnormal stresses and unacceptable instability in use.

### DISCLOSURE OF THE INVENTION

The aim of the present invention is to obviate the drawbacks cited above by providing a wheel that has high characteristics of rigidity and stability in use combined with low weight and versatility in use.

Within this aim, an object of the present invention is to provide a wheel in which the wire spokes cross each other, connecting the rim to the hub, without mutual contact points.

Another object of the present invention is provide a structure that is simple, relatively easy to provide in practice, safe in use, effective in operation, and relatively low in cost.

This aim and these and other objects are achieved by the present bicycle wheel, particularly for racing and mountain bicycle, which comprises a hub that has two flanges connected to a rim by way of wire spokes, characterized in that said wire spokes form a first plurality of radial elements, which are mutually angularly equidistant by a preset angle and connect said rim to the first flange of said hub, and a second plurality of radial elements, which are mutually angularly equidistant by said angle, are offset by half of said angle with respect to said first plurality and connect said rim to the second flange of said hub, each one of said radial elements being constituted by a first wire spoke and a second wire spoke which are substantially parallel.

### BRIEF DESCRIPTION OF THE DRAWINGS

Further characteristics and advantages will become better apparent from is the detailed description of a preferred but not exclusive embodiment of a bicycle wheel, particularly for racing and mountain bicycle, according to the invention, illustrated only by way of non-limitative example in the accompanying drawings, wherein:

FIG. 1 is a side elevation view of the wheel according to the invention;

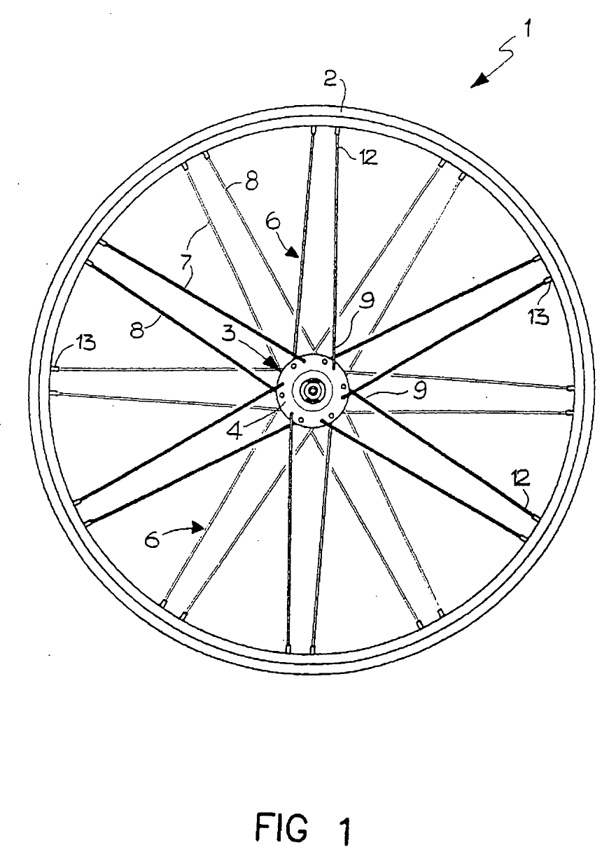

FIG. 2 is a side elevation view of a detail of the hub of the wheel;

FIG. 3 is a detailed side elevation view of a sector of the wheel:

FIG. 4 is a side elevation view of another embodiment of the wheel according to the invention;

FIG. 5 is a side elevation view of a detail of the hub of the wheel of FIG. 4;

FIG. 6 is a diametrical sectional view of the wheel, taken along the line VI-VI of FIG. 4.

### WAYS OF CARRYING OUT THE INVENTION

In the examples of embodiment that follow, individual features, presented in relation to specific examples, may actually be interchanged with other different features that exist in other examples of embodiment.

With reference to the figures, the reference numeral 1 generally designates a bicycle wheel particularly for a racing and mountain bicycle according to the invention.

The wheel comprises a rim 2 and a central hub 3, which are mutually connected by a distribution of wire spokes: the hub 3 has a first flange 4 and a second flange 5 which are lateral, are substantially disk-like and have respective inner faces 4a, 5a and outer faces 4b, 5b.

According to the invention, the wire spokes form a first plurality of radial elements 6, which connect the first flange 4 to the rim 2 and are mutually angularly equidistant by a preset angle, and a second plurality of radial elements 6, which are mutually angularly equidistant by the same angle and connect the second flange 5 to the rim 2.

The first and second pluralities of radial elements 6 are mutually offset, preferably by half of such preset angle. In the specific case, by way of example, for each of the two pluralities there are six radial elements 6 that are mutually angularly spaced by 60°; accordingly, the first and second pluralities of radial elements are mutually offset by 30°.

Each one of the radial elements 6 that connect the two flanges 4 and 5 of the hub 3 to the rim 2 is constituted by a first wire spoke 7 and by a second wire spoke 8, which are substantially parallel or, in a fully equivalent manner, converge slightly in a centripetal direction.

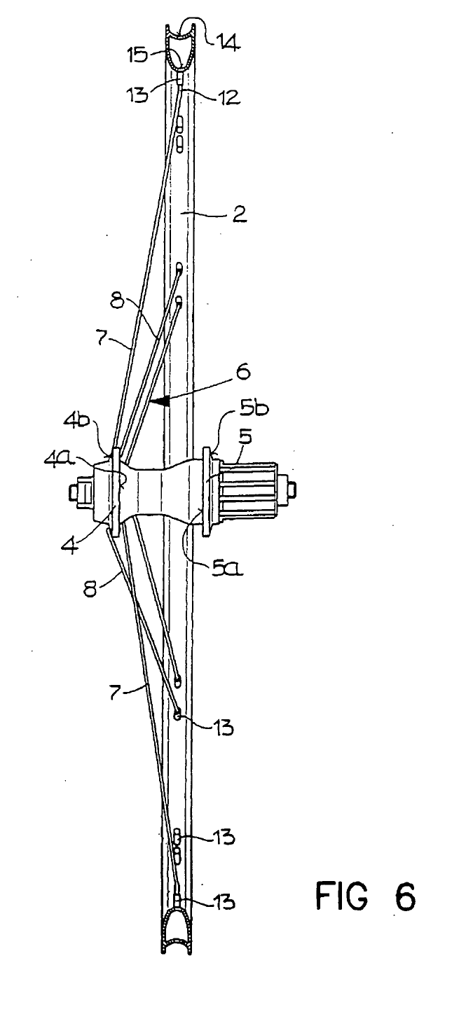

The wire spokes 7 and 8 are of the type in which the proximal end 9 is folded and engaged in a respective engagement hole 10 provided peripherally in the flange 3 and 4; the spoke also forms, at the proximal end 9, a larger portion 11 for retention in the hole 10. Preferably, for each one of the radial elements 6 of the wheel, the first wire spoke 7 is inserted in the respective hole 10 so that the larger portion 11 is engaged against the inner face 4a, 5a of the respective flange 4 and 5, while the larger portion 11 of the second wire spoke 8 is engaged against the outer face 4b, 5b (see FIG. 6) of the same flange. The distal end 12 of each wire spoke 7 and 8 is instead threaded and screwed into a respective cylindrical nipple 13, which is rigidly coupled to the rim 2. The distal end 12 and the proximal end 9 of the wire spokes 7 and 8 have a circular cross-section, while the central portion preferably has a substantially flattened cross-section.

The nipples 13 are distributed along the rim 2 in pairs that are mutually angularly equidistant, for fixing respectively the first and second wire spokes 7 and 8 of each radial element 6. The nipples 13 of each pair are adjacent and are arranged at a regular circumferential distance.

The rim 2 is internally hollow and has a peripheral groove 14 for accommodating the tire and a plurality of radial openings 15 for accommodating the respective nipples 13.

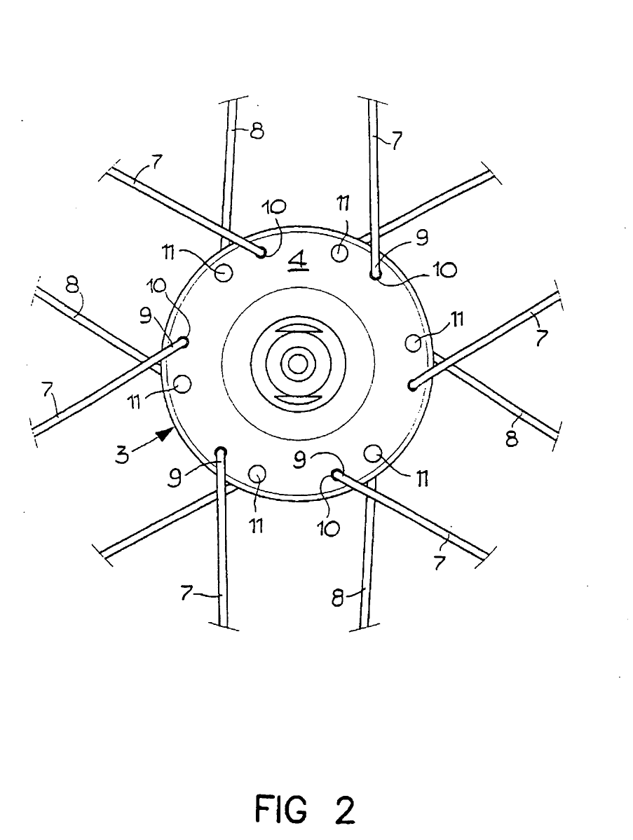

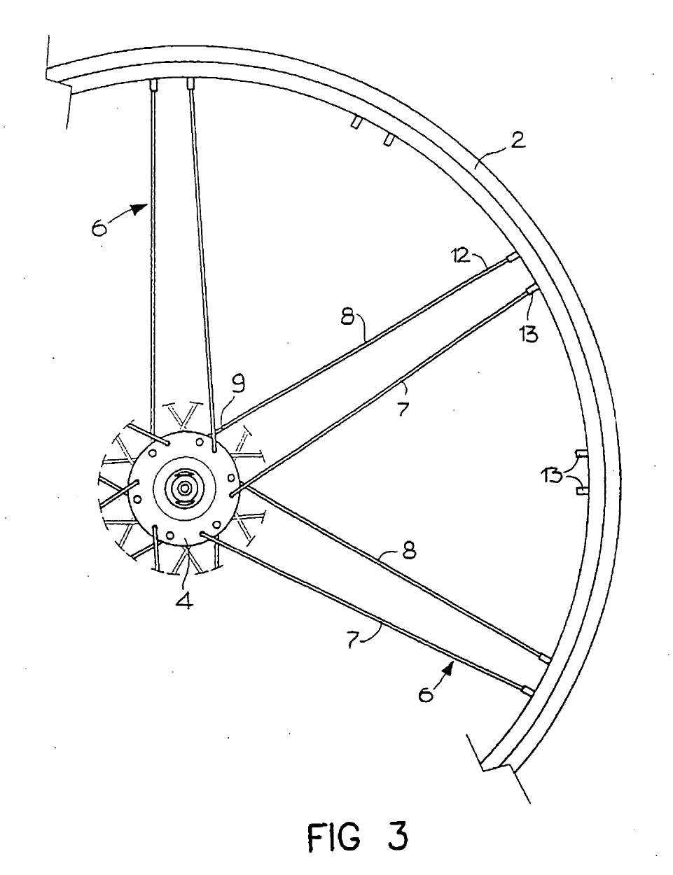

The engagement holes 10 for the wire spokes 7 and 8 are uniformly distributed, on each one of the flanges 4 and 5, substantially in mutually angularly equidistant pairs: the first wire spoke 7 of each one of the elements 6 and the second wire spoke 8 of the directly contiguous element respectively engage in each hole 10 of those pairs. The wire spokes are fixed to the respective nipples 13 so as to cross each other proximate to the flange 4 and 5 without mutual contact (reference should be made, in this regard, to FIGS. 2 and 3, which illustrate the radial elements 6 of only one of the two pluralities).

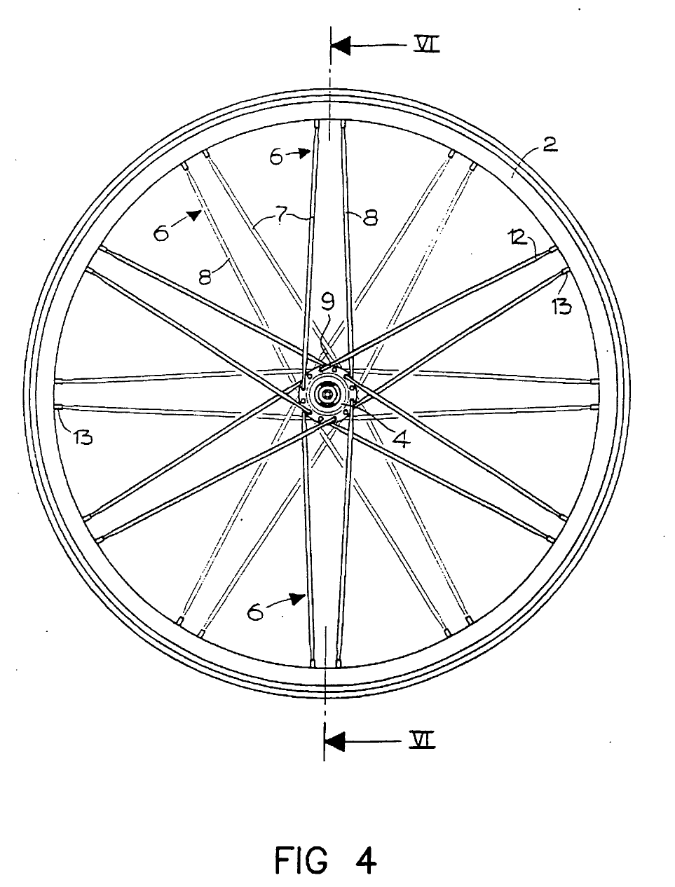

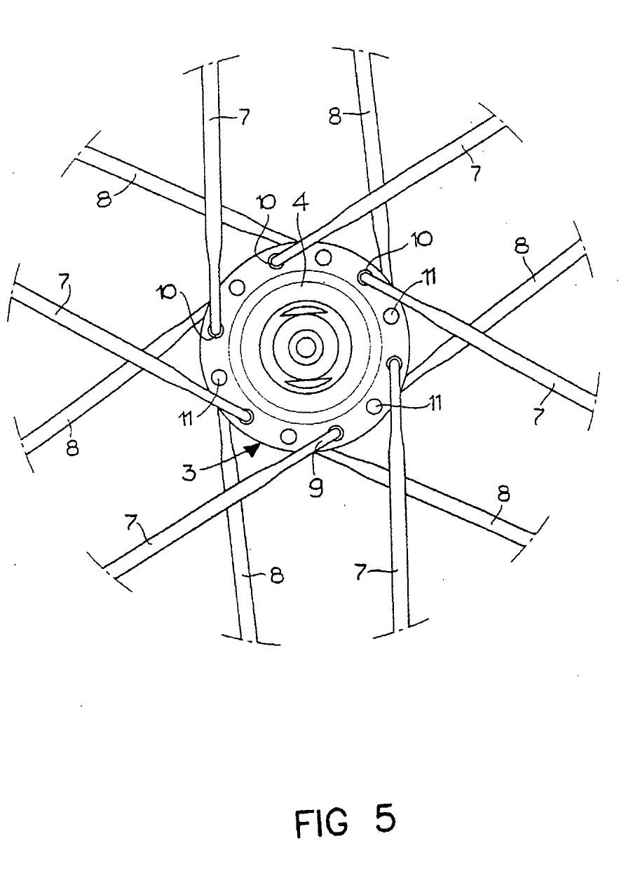

FIGS. 4, 5 and 6 relate to a further embodiment of the wheel according to the invention. In these figures, elements identical or corresponding to elements of the previous figures are designated by the same reference numerals. In this embodiment, a hub 3 is assembled in which the holes 10 for engaging the wire spokes 7 and 8 are angularly mutually equidistant in each one of the flanges 4 and 5.

In each one of the flanges 4 and 5, the radial elements 6 are engaged in the holes 10 so that the first wire spoke 7 of each odd element 6 (the first, third and fifth elements) crosses, without mutual contact, the second wire spoke 8 of the contiguous odd elements; therefore, for example, the second wire spoke 8 of the first element crosses the first wire spoke 7 of the third element. In the same manner, the first wire spoke 7 of each even element 6 (the second, fourth and sixth elements) crosses, without mutual contact, the second wire spoke 8 of the contiguous even element.

The distribution of the radial elements 6 in the holes 10 described above also allows the crossing, without mutual contact, of the first wire spoke 7 of each radial element 6 and of the second wire spoke 8 of the directly adjacent radial element, as shown in particular in FIG. 6.

It is noted that the transverse cross-section of the spokes 7 and 8 can be of any kind, but must maintain the particular mechanical behavior of each element 6 in use, which can be likened to that of a solid spoke of a pressure die-cast wheel.

Moreover, the arrangement of the wire spokes 7 and 8 with crossings without contact in one or more points ensures higher stability, strength and rigidity of the wheel in any operating situation.

It has thus been shown that the invention achieves the intended aim and objects.

The invention thus conceived is susceptible of numerous modifications and variations, all of which are within the scope of the appended claims.

All the details may further be replaced with other technically equivalent ones.

In practice, the materials used, as well as the shapes and the dimensions, may be any according to requirements without thereby abandoning the scope of the protection of the appended claims.

The disclosures in Italian Utility Model No. BO2001U000092 from which this application claims priority are incorporated herein by reference.

1. A bicycle wheel, particularly for racing and mountain bicycle, comprising a hub that has two flanges connected to a rim by way of wire spokes, characterized in that said wire spokes form a first plurality of radial elements, which are mutually angularly equidistant by a peset angle and connect said rim to the first flange of said hub, and a second plurality of radial elements, which are mutually angularly equidistant by said angle, are offset by half of said angle with respect to said first plurality and connect said rim to the second flange of said hub, each one of said radial elements being constituted by a first wire spoke and a second wire spoke which are substantially parallel.

2. The wheel according to claim 1, characterized in that said first wire spoke and said second wire spoke of each one of said radial elements are engaged on opposite sides with the respective flange and in that said first wire spoke of one element is engaged with said flange in a position that is intermediate with respect to the engagement points of said first and second spokes of the contiguous element.

3. The wheel according to claim 1, characterized in that said first wire spoke and said second wire spoke of alternated of said radial elements are engaged on a same side of said flange, the remaining radial elements being engaged with the opposite side of said flange

4. The wheel according to claim 2, characterized in that said first wire spoke and said second wire spoke have a proximal end that is associated with said hub and a distal end that is proximate to said rim, said proximal end being folded and inserted in a respective peripheral engagement hole provided in said flange, said distal end being screwed into a nipple that is rigidly coupled to said rim, said first wire spoke and said second wire spoke forming, at said proximal ends, larger portions for abutment respectively against the inner face and the outer face of said flange.

5. The wheel according to claim 2, characterized in that said holes are distributed, on each one of said flanges, in angularly equidistant pairs, the first wire spoke of one element and the second wire spoke of the contiguous element being engaged respectively in each one of said pairs of holes, so as to cross without mutual contact.

6. The wheel according to claim 1, characterized in that each one of said wire spokes has a circular transverse cross-section at said distal end and said proximal end, and a substantially flat cross-section in the central portion.

7. The wheel according to claim 2, characterized in that said nipples are distributed, along said rim, in pairs that are angularly mutually equidistant for fixing respectively said first wire spoke and said second wire spoke of each one of said radial elements.

8. The wheel according to claim 2, characterized in that said rim is internally hollow, has a peripheral groove for the application of the tire and is affected by a plurality of radial openings for accommodating said nipples.
